(19) United States
(12) Patent Application Publication
(10) Pub. No.: US 2011/0239840 A1
(43) Pub. Date: Oct. 6, 2011

(54) CUTTING OBJECT CUTTING DEVICE AND INKJET PAPER FABRICATION DEVICE

(75) Inventors: Tatsuhito OHYABU, Kanagawa (JP); Kyohisa UCHIUMI, Kanagawa (JP)

(73) Assignee: FUJIFILM CORPORATION, Tokyo (JP)

(21) Appl. No.: 13/011,932

(22) Filed: Jan. 24, 2011

(30) Foreign Application Priority Data
Mar. 31, 2010 (JP) 2010-081839

(51) Int. Cl. B26D 1/22

(52) U.S. Cl. 83/505

(57) ABSTRACT

A cutting device is provided with a lower blade, an upper blade and a collar. Inkjet paper, in which an ink-receiving layer is formed on paper, is wound around an outer periphery face of the lower blade, and a blade tip is formed at one axial direction end of the lower blade. The upper blade rotates with a blade tip thereof opposing the blade tip of the lower blade in the axial direction, and the upper blade cuts the inkjet paper from the paper side thereof. The collar supports the inkjet paper, which is wound around the collar at a position that is separated from the lower blade in the axial direction. A portion of the collar, including shoulder curve portions at the two axial direction ends thereof, is constituted with PTFE.

### CROSS-REFERENCE TO RELATED APPLICATION

This application claims priority under 35 USC 119 from Japanese Patent Application No. 2010-081839, filed on Mar. 31, 2010, the disclosure of which is incorporated by reference herein.

### BACKGROUND OF THE INVENTION

1. Field of the Invention

The present invention relates to a cutting device for a cutting object in which a coating layer is formed on a substrate, and to a fabrication device for inkjet paper.

2. Description of the Related Art

A technology is known (for example, see the specification of United States Patent Application Publication No. 2004/0255743) in which an inkjet paper has a relatively stiff coating layer formed on a substrate and this inkjet paper is supported by a lower blade and cut, from the coating layer side, by a sharp upper blade. Meanwhile, for the cutting of photographic printing paper, a technology is known that cuts from the substrate side (for example, see the specification of U.S. Pat. No. 5,974,922).

However, when a cutting object with a coating layer that is harder than a substrate is cut by an upper blade from the coating layer side, it is difficult to obtain an excellent cut face, which leads to a deterioration in yield. On the other hand, if a cutting object with a coating layer that is harder than a substrate is cut by an upper blade from the substrate side, there is a risk of the surface of the coating layer of the cutting object being damaged because of the coating layer being scraped in accordance with relative displacement, relative to the coating layer, of a support member and the lower blade.

### SUMMARY OF THE INVENTION

An object of the present invention is to provide a cutting object cutting device that contributes to the fabrication of a cutting object with an excellent cut face and coating layer surface. A further object of the present invention is to provide an inkjet paper fabrication device that is capable of fabricating inkjet paper with an excellent cut face and coating layer surface.

A cutting object cutting device relating to a first aspect of the present invention includes: a lower blade that is formed in a circular tube shape around which a cutting object is wound, a blade tip being formed at an outer periphery portion of the lower blade at one end of an axial direction thereof, and the lower blade rotating in a direction of running of the cutting object in the state in which the cutting object is wound therearound, and the cutting object including a coating layer formed on a substrate, the coating layer being harder than the substrate; an upper blade, at an outer periphery portion of which a blade tip that progressively narrows toward a radial direction outer side is formed, the upper blade cutting the cutting object from the substrate side thereof while rotating about an axis that is parallel to the axis of the lower blade such that the blade tip opposes the blade tip of the lower blade; and a support member that is disposed so as to rotate coaxially and integrally with the lower blade at a position that is separated from the lower blade in the axial direction, at least an axial direction end portion of the support member being constituted with a resin material, the support member rotating together with the lower blade, and the supporting member supporting the cutting object with the cutting object being wound around the support member at a portion including the axial direction end portion.

In the cutting object cutting device of the first aspect of the present invention, while the cutting object that has been wound thereon is supported by the lower blade and the support member, the blade whose blade tip is opposed with the blade tip of the lower blade cuts the cutting object from the substrate side. Thus, an excellent cut face is obtained on the cutting object. Because at least the axial direction end portion of the support member is formed of a resin, which is relatively flexible and excellent in sliding characteristics, damage to the surface of the coating layer wound around the support member is prevented or effectively suppressed.

Thus, the cutting object cutting device relating to the first aspect of the present invention contributes to fabricating a cutting object with an excellent cut face and coating layer surface. As an example of the resin material constituting the support member, polytetrafluoroethylene (PTFE) may be employed.

In the cutting object cutting device relating to the first aspect of the present invention, the support member may be disposed so as to sandwich the blade tip of the upper blade between the support member and the lower blade in the axial direction, at least both end portions of the support member in the axial direction may be constituted with the resin material, and curves (rounded portions) may be specified at corners of the end portions.

In the cutting object cutting device with the structure described above, the blade tip of the upper blade is inserted between the lower blade and the support member and cuts the cutting object. In the wound around state of the support member, both ends in the axial direction, which are portions at which stresses are likely to be concentrated in the supported cutting object, are structured of the resin material and the curves (radiuses) are specified at the corners. Therefore, concentrations of stress in the cutting object are moderated, and damage to the surface of the coating layer of the cutting object is prevented or effectively suppressed.

In the cutting object cutting device relating to the above structure, a radius of the curves of the support member may be specified in a range from 3 mm to 12 mm.

In the cutting object cutting device with the structure described above, because the curve of the support member is set in the range from 3 mm to 12 mm, concentrations of stress on the cutting object, which are a concern below the lower limit of the range, and support problems, which are a concern above the upper limit, are both suppressed.

In the cutting object cutting device relating to the first aspect of the present invention, the whole of the support member may be integrally constituted of the resin material.

In the cutting object cutting device with the structure described above, because the support member as a whole is formed of the resin material, damage to the surface of the coating layer of the cutting object is prevented or effectively suppressed. In addition, fabrication of the support member is simple.

In the cutting object cutting device relating to the first aspect of the present invention, the lower blade may include a small diameter portion at the axial direction end portion that is at the opposite side thereof from the side at which the blade tip is disposed, the small diameter portion being set to a smaller diameter than other portions of the lower blade, and the cutting object cutting device may further include a cover member made of resin that covers the small diameter portion from the outer periphery side thereof, and that rotates together with the lower blade while supporting the cutting object, the cutting object being wound around the cover member.

In the cutting object cutting device with the structure described above, the cover member made of the resin, which is relatively soft and excellent in sliding characteristics, supports the cutting object at the axial direction end portion at the side of the lower blade opposite from the blade tip, which is a portion at which stress is likely to be concentrated in the cutting object. Therefore, concentrations of stress in the cutting object from the lower blade, even at the support ends, are moderated, and damage to the surface of the coating layer of the cutting object is prevented or effectively suppressed.

In the cutting object cutting device relating to the above structure, the small diameter portion of the lower blade may be a curve (a curved portion) specified at a corner portion, the cover member may be structured to include a cover portion that covers the curve from the outer periphery side and a support portion that supports the cutting object at the opposite side of the cover portion from the side at which the lower blade is disposed, and the support portion of the cover member may include a curve at a corner of an axial direction end portion thereof, the curve being specified with a radius in a range from 3 mm to 12 mm.

In the cutting object cutting device with the structure described above, the small diameter portion of the lower blade is specified by the curve (curve machining), and because this curve is covered by the cover portion of the cover member, concentrations of stress in the cutting object are moderated. In addition, because the support portion of the cover member is also supported in the state in which the cutting object is wound thereon, and the curve at the support portion is set to a radius of 3 mm to 12 mm, similarly to the side that is supported by the above-described support member, damage to the surface of the coating layer of the cutting object is prevented or effectively suppressed at the lower blade side.

The cutting object cutting device relating to the above structure may further include: a retention member that retains the support member mating (fitting) with a first mating portion (first fitting portion) that is longer than a width along the axial direction of the support member, and that retains the lower blade mating (fitting) with a second mating portion (second fitting portion) with a smaller diameter than the first mating portion; and a spacer member that abuts against a step portion between the second mating portion and the first mating portion and that protrudes to the radial direction outer side relative to the first mating portion, and that regulates a gap in the axial direction between the support member and the lower blade.

In the cutting object cutting device with the structure described above, the support member and the lower blade are retained by being mated with the common retention member. Because the spacer member mated with the step portion between the first mating portion and the second mating portion protrudes to the radial direction outer side relative to the first mating portion, the support member is prevented from falling to the lower blade side from the first mating portion. Meanwhile, the lower blade mated with the second mating portion is restricted in movement toward the support member by the spacer member. Thus, a spacing in the axial direction between the lower blade and the support member is restricted to a predetermined range. In addition, because the width of the support member is smaller than the length of the first mating portion, the support member including the resin portion, which is relatively easy to deform, does not receive a restraining force from the spacer member, and dimensional precision of the support member is maintained.

In the cutting object cutting device relating to the above structure, the spacer member may include a ring member, an outer diameter of which is larger in diameter than the first mating portion and an inner periphery of which mates with the second mating portion, and that is interposed between the lower blade and the step portion.

In the cutting object cutting device with the structure described above, because the spacer member is a ring member mated with the second mating portion, assembly of the support member, the ring member and the lower blade are simple, and dimensional precision is easy to achieve.

The cutting object cutting device relating to the above structure may further include a push plate that is fastened to the retention member from the opposite side of the lower blade from the side at which the spacer member is disposed, the lower blade being interposed between the push plate and the spacer member, and the cover member may be disposed at an outer periphery portion of the push plate.

In the cutting object cutting device with the structure described above, because the push plate is fastened to the retention member, the lower blade is interposed between the push plate and the spacer member (the step portion between the first and second mating portions), and thus the lower blade is firmly retained at the retention member. Because the above-mentioned cover member is provided at the outer periphery of this push plate, deformation of the cover member by the fastening is prevented or effectively suppressed. That is, dimensional precision of the cover member is maintained.

In the cutting object cutting device relating to the first aspect of the present invention, a tension of the cutting object may be specified in a range from 166 N/m to 731 N/m.

In the cutting object cutting device with the structure described above, tension on the cutting object during cutting is set in the range from 166 N/m to 731 N/m. Therefore, the cutting object is cut in a stable condition, which contributes to assuring cutting quality. Moreover, because the upper limit of the tension is specified, forces of the cutting object pushing against the support member and the lower blade are not a problem, and damage to the surface of the coating layer of the cutting object is prevented or effectively suppressed.

An inkjet paper fabrication method relating to a second aspect of the present invention includes: a running mechanism that runs inkjet paper in which an ink-receiving layer is formed on a substrate, the ink-receiving layer being harder than the substrate; and a cutting object cutting device according to the first aspect of the present invention that is disposed on a path of running of the inkjet paper due to the running mechanism and that cuts the inkjet paper, which serves as the cutting object.

In the inkjet paper fabrication device with the structure described above, the inkjet paper being run by the running mechanism serves as the cutting object and is cut by a cutting object cutting device described above. Therefore, inkjet paper with an excellent cut face and coating layer surface may be fabricated.

A cutting object cutting device relating to the present invention as described hereabove has an excellent effect in contributing to fabricating cutting objects with excellent cut faces and coating layer surfaces. The present invention has a further excellent effect in that inkjet papers with excellent cut faces and coating layer surfaces may be fabricated.

### BRIEF DESCRIPTION OF THE DRAWINGS

FIG. 1 is a sectional diagram illustrating principal portions of a lower blade unit that structures a cutting device relating to an exemplary embodiment of the present invention.

FIG. 2 is a front view illustrating the principal portions of the lower blade unit that structures the cutting device relating to the exemplary embodiment of the present invention.

FIG. 3 is a sectional diagram illustrating a portion of the lower blade that is covered by a cover member that structures the cutting device relating to the exemplary embodiment of the present invention.

FIG. 4 is a sectional diagram illustrating a magnification of blade tips of an upper blade and the lower blade that structure the cutting device relating to the exemplary embodiment of the present invention.

FIG. 5 is a side view schematically illustrating an inkjet paper fabrication device relating to the exemplary embodiment of the present invention.

FIG. 6 is a front view illustrating the cutting device relating to the exemplary embodiment of the present invention.

FIG. 7A is a front view illustrating a cutting state of the cutting device relating to the exemplary embodiment of the present invention.

FIG. 7B is a plan view illustrating inkjet paper that has been cut by the cutting device relating to the exemplary embodiment of the present invention.

FIG. 8 is a diagram illustrating the cutting device relating to the exemplary embodiment of the present invention, which is a sectional diagram taken along line 8-8 of FIG. 7A.

FIG. 9 is a front view illustrating principal portions of a lower blade unit that structures a cutting device relating to Comparative Examples.

### DETAILED DESCRIPTION OF THE INVENTION

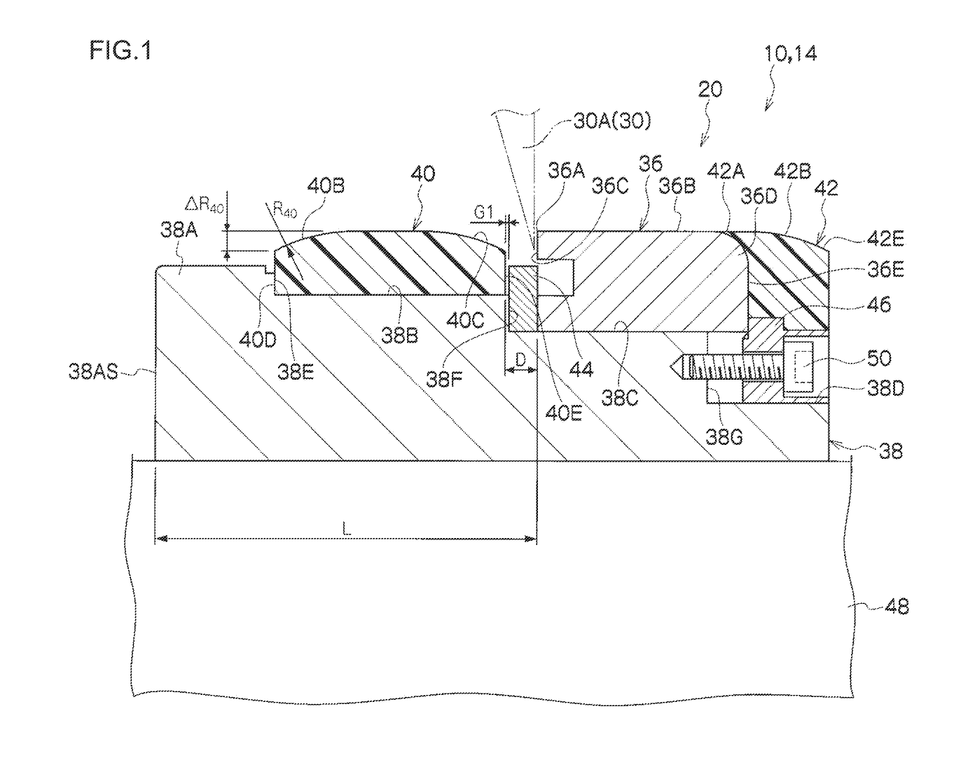

A cutting object cutting device and cutting object cutting method relating to an exemplary embodiment of the present invention are described for an inkjet paper fabrication device 10 in accordance with FIG. 1 to FIG. 8. First, schematic overall structure of the inkjet paper fabrication device 10 is described, and then a cutting device 14 that serves as the cutting object cutting device, which is a principal element of the present invention, is described in detail.

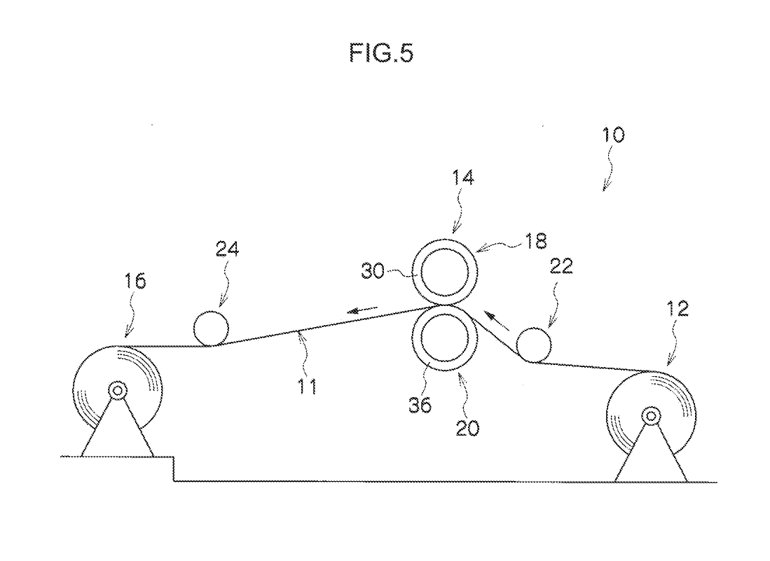

FIG. 5 illustrates schematic structure of the inkjet paper fabrication device 10 in a schematic diagram. As illustrated in this diagram, the inkjet paper fabrication device 10 is provided with a feeding section 12, the cutting device 14 and a winding section 16. The feeding section 12 feeds out inkjet paper 11, which serves as the cutting object. The cutting device 14 cuts the inkjet paper 11 fed out from the feeding section 12. The winding section 16 winds up the inkjet paper 11 that has been cut by the cutting device 14.

The feeding section 12 sequentially feeds out the inkjet paper 11, which has been wound up in a roll. The inkjet paper 11 is plurally cut respectively to a narrow width, and the winding section 16 has a structure that individually winds up and collects the inkjet papers 11 in rolls. Thus, the inkjet paper 11 runs between the feeding section 12 and the winding section 16 (see the arrows in FIG. 5). A drive source is provided at the winding section 16 and constitutes a running mechanism. The winding section 16 may have a single shaft as illustrated in FIG. 5 or, although not illustrated, may have two shafts whose axial positions are offset from one another.

As detailed herebelow, at the cutting device 14, the inkjet paper 11 is interposed between an upper blade unit 18 and a lower blade unit 20, and the cutting device 14 cuts the inkjet paper 11 into a plural number of divisions in the width direction (a direction orthogonal to the running direction). A guide roller 22 is provided between the feeding section 12 and the cutting device 14, and the inkjet paper 11 is wound around the guide roller 22. A guide roller 24 is provided between the cutting device 14 and the winding section 16, and the inkjet papers 11 are wound around the guide roller 24.

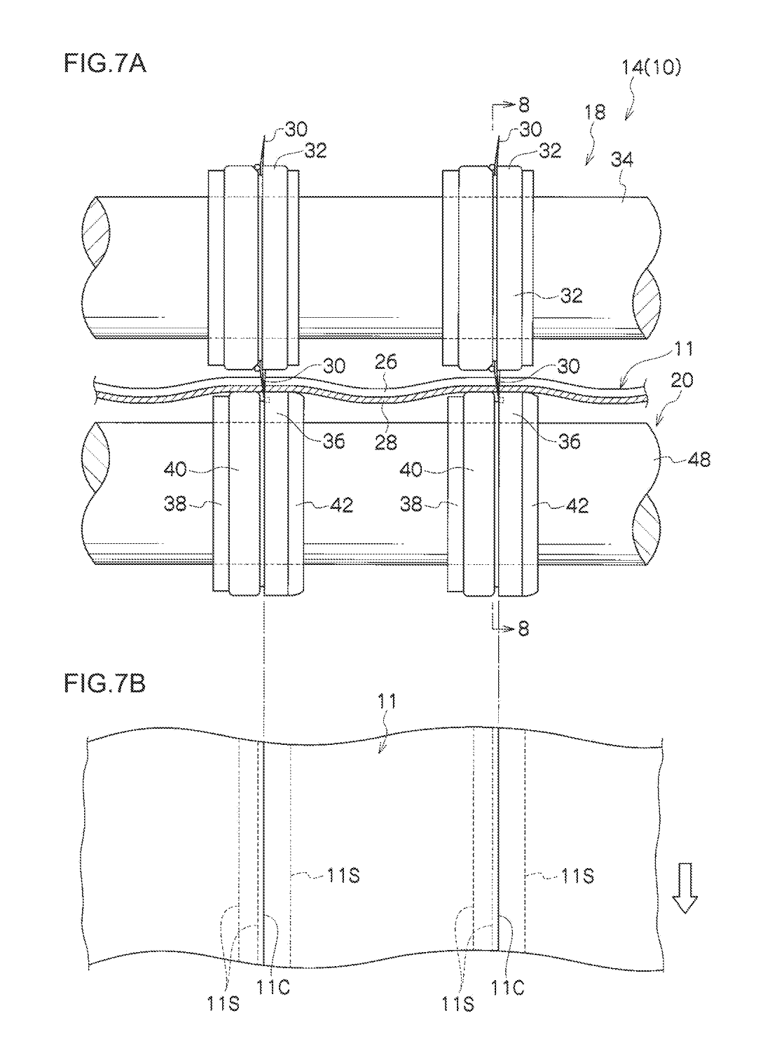

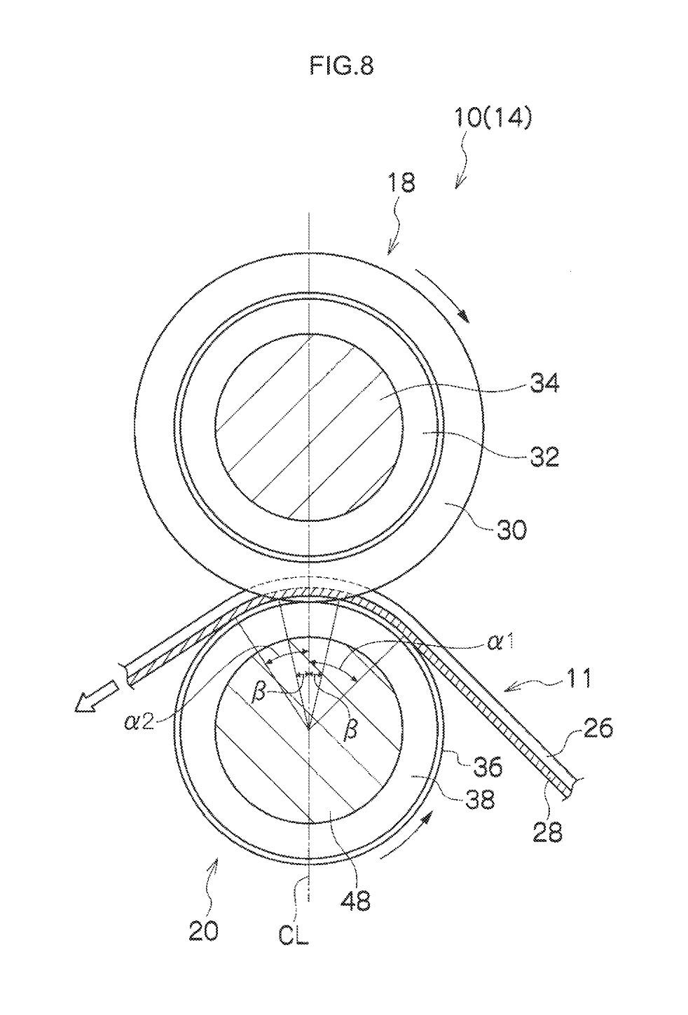

Now the inkjet paper 11 is supplementary described. In the inkjet paper 11, as illustrated in FIG. 7A, FIG. 7B and FIG. 8, an ink-receiving layer 28, which serves as a coating layer, is formed on one face of paper 26, which serves as a substrate. The ink-receiving layer 28 is formed by coating a coating liquid onto the paper 26 and drying the same. The coating liquid includes inorganic microparticles (silica in this exemplary embodiment), an aqueous resin (for example, polyvinyl alcohol), a solvent (for example, a cationic compound) and a cross-linking agent and the like. The silica forms a porous network structure on the one face of the paper 26. Thus, the ink-receiving layer 28 is made stiffer than the paper 26. As specific structural materials of the paper and the inorganic microparticles, the aqueous resin, the solvent and the cross-linking agent constituting the inkjet paper 11, the materials recited in, for example, Japanese Patent Application Laid-Open (JP-A) No. 2010-30195 may be employed.

—Structure of Cutting Device—

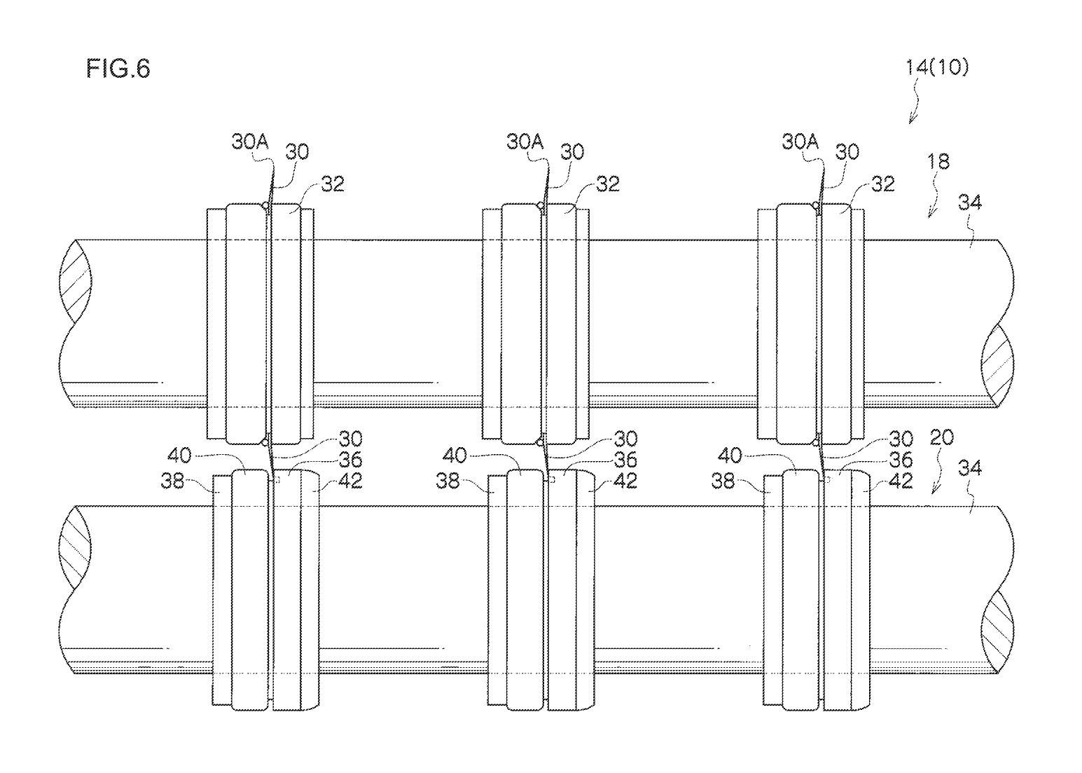

FIG. 6 illustrates schematic structure of the cutting device 14 in a front view in which the inkjet paper 11 is not shown. FIG. 7A illustrates the cutting device 14 in a state of cutting the inkjet paper 11 in a front view. FIG. 7B illustrates the inkjet paper 11 after cutting in a plan view. FIG. 8 illustrates a sectional diagram taken along line 8-8 of FIG. 7A.

As illustrated in these drawings, the upper blade unit 18 is provided with a plural number of upper blades 30, upper blade holders 32 and an upper blade rotation axle 34. Each upper blade 30 is formed in an annular shape in side view, and an outermost periphery portion thereof serves as a sharp blade tip 30A that is oriented to the radial direction outer side (forming a cutting angle of approximately 20 to 50°). That is, the blade tip 30A is structured to be progressively thinner toward the radial direction outer side. Details of the shape of the blade tip 30A will be described below along with the shape of a blade tip 36A of a lower blade 36.

The upper blade holder 32 retains the upper blade 30 so as to rotate coaxially and integrally with the upper blade rotation axle 34. Positions of retention of the upper blades 30 in the axial direction of the upper blade rotation axle 34 are adjustable. Adjustment structures thereof are widely known and so are not described. Thus, in the cutting device 14, cutting positions in the width direction of the inkjet paper 11, which is to say, widths of the inkjet papers 11 after cutting, may be adjusted.

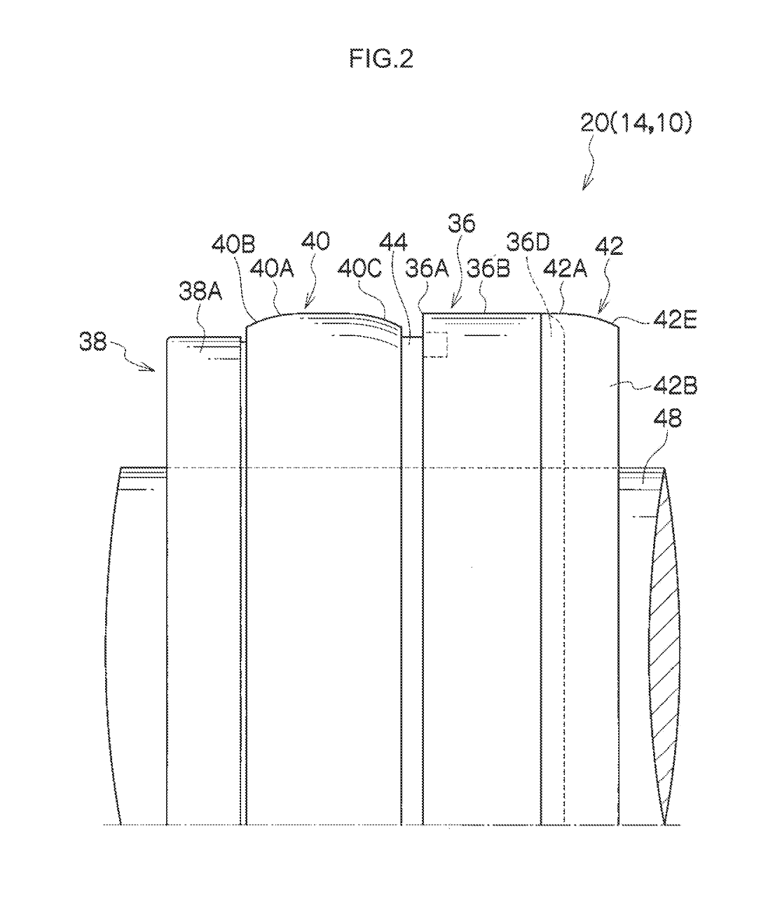

As illustrated in FIG. 1 and FIG. 2, the lower blade unit 20 is structured with principal elements thereof being the lower blades 36, which match the upper blades 30 in number, lower blade holders 38, collars 40 that serve as support members, cover members 42, middle rings 44 that serve as spacer members or ring members, push plates 46 and a lower blade rotation axle 48.

While each lower blade holder 38 retains the lower blade 36, the collar 40, the cover member 42, the middle ring 44 and the push plate 46, a retention position of these components in the axial direction of the lower blade rotation axle 48 may be adjusted. Adjustment structures thereof are widely known and so are not described. Thus, in the cutting device 14, the cutting positions in the width direction of the inkjet paper 11, which is to say, the widths of the inkjet papers 11 after cutting, may be adjusted to match the adjustment positions at the upper blade unit 18.

Each lower blade 36 is formed in a short circular tube shape, and (a principal portion of) an outer periphery face 36B thereof is a tubular surface. The blade tip 36A is formed at the outer periphery of the lower blade 36 at one end thereof in the axial direction, which is the rotation axle direction. In the broader sense, the blade tip 36A may be understood as being a blade at approximately 90°. At the collar 40, (a principal portion of) an outer periphery face 40A thereof is formed in a short circular tube shape to form a tubular surface. The collar 40 is disposed adjacent to the lower blade 36 at the blade tip 36A side thereof.

The outer periphery face 40A of the collar 40 and the outer periphery face 36B of the lower blade 36 protrude further out in the radial direction than other portions of the lower blade unit 20, and have substantially the same diameter as one another. As illustrated in FIG. 7A, the inkjet paper 11 is supported from the ink-receiving layer 28 side thereof. In this supported state, as illustrated in FIG. 8, the inkjet paper 11 is wound around the outer periphery faces 40A of the collars 40 and the outer periphery faces 36B of the lower blades 36.

As illustrated in FIG. 1, each blade tip 30A is inserted between the blade tip 36A of the lower blade 36 and the collar 40 so as to oppose the blade tip 36A in the axial direction. Thus, while rotating, the upper blade 30 cuts the inkjet paper 11 from the paper 26 side thereof (the opposite side from the coated surface).

In the lower blade holder 38, a base portion 38A, a first mating portion 38B, a second mating portion 38C and a third mating portion 38D are formed in this order from one end in the axial direction. The base portion 38A is fixed to the lower blade rotation axle 48 and acts as a positional reference relative to the lower blade rotation axle 48. The first mating portion 38B has a smaller diameter than the base portion 38A, the second mating portion 38C has a smaller diameter than the first mating portion 38B, and the third mating portion 38D has a smaller diameter than the second mating portion 38C. Thus, in the lower blade holder 38, a step portion 38E is formed between the base portion 38A and the first mating portion 38B, a step portion 38F is formed between the first mating portion 38B and the second mating portion 38C, and a step portion 38G is formed between the second mating portion 38C and the third mating portion 38D.

The lower blade 36 is mated with the second mating portion 38C of the lower blade holder 38, and is retained so as to rotate integrally with the lower blade holder 38 by the push plate 46, which is fastened to the lower blade holder 38 with a bolt 50. More specifically, the bolt 50 passes through a bolt hole in the push plate 46 and is threaded into the step portion 38G, and thus the push plate 46 presses the lower blade 36 toward the step portion 38F from the axial direction other side of the lower blade 36 (the opposite side thereof from the side at which the blade tip 36A is disposed). The middle ring 44 is interposed between the step portion 38F and an end face 36C at the blade tip 36A side of the lower blade 36. That is, the lower blade 36 is interposed between the push plate 46 and the middle ring 44 and is retained at the lower blade holder 38.

The position in the axial direction of the blade tip 36A is regulated by the lower blade 36 abutting against (the step portion 38F via) the middle ring 44. In this exemplary embodiment, a distance L in the axial direction from a reference surface 38AS of the base portion 38A to the blade tip 36A is specified as a tolerance range.

An axial direction end portion of the lower blade 36 at the opposite side thereof from the side at which the blade tip 36A is provided is formed as a shoulder curve portion 36D, with a specified curve. The shoulder curve portion 36D may be understood as a small diameter portion with a smaller diameter than the outer periphery face 36B. This shoulder curve portion 36D has a curve with a radius R₃₆ of 3 mm, and is covered by the cover member 42. As described in detail below, the cover member 42 is formed integrally with an outer periphery portion of the push plate 46.

The collar 40 is mated with the first mating portion 38B of the lower blade holder 38, and movement thereof in the axial direction is restricted by the step portion 38E and the middle ring 44. That is, the outer diameter of the middle ring 44 mated with the second mating portion 38C is larger than the outer diameter of the first mating portion 38B (the inner diameter of the collar 40) but smaller than the outer diameter of the collar 40. A gap G1 between the collar 40 and the middle ring 44 is set to approximately 0.1 mm in a state in which the collar 40 is disposed closer to the step portion 38E.

Thus, the collar 40 is retained at the lower blade holder 38 without being subjected to a restraining force in the axial direction (a fastening load from the bolt 50). The collar 40 is a structure in which a gap D between the collar 40 and the end face 36C at the blade tip 36A side of the lower blade 36 is maintained within a tolerance range by the middle ring 44. This gap D is set in a range from 3 mm to 9 mm, and is 3 mm in this exemplary embodiment.

The collar 40 is made of resin. More specifically, the collar 40 is constituted with PTFE (polytetrafluoroethylene). The PTFE is a material with lower resilience and lower friction than a steel material that constitutes the lower blade 36. In this exemplary embodiment, the whole of the collar 40, including the two axial direction end portions thereof, is integrally formed of PTFE.

The corner portions at the two axial direction ends of the collar 40 are formed as shoulder curve portions 40B and 40C at which curves are specified. A radius R₄₀ of these shoulder curve portions 40B and 40C is set in a range from 3 mm to 12 mm. In this exemplary embodiment, R₄₀ is set to equal 9 mm. The shoulder curve portions 40B and 40C are set to a range of less than 90°. Rather than being smoothly joined to the tubular surface of the outer periphery face 40A, the shoulder curve portions 40B and 40C form corners with two axial direction end faces 40D and 40E of the collar 40. Thus, the shoulder curve portions 40B and 40C are set to relatively large radiuses on the collar 40 whose width in the axial direction is limited. In this exemplary embodiment, a radius difference ΔR₄₀ between a radius of the corner portions between the shoulder curve portions 40B and 40C and the end faces 40D and 40E and the radius of the outer periphery face 40A is 3 mm.

The cover member 42 is made of resin, and in the present exemplary embodiment is constituted with PTFE similarly to the collar 40. The cover member 42 is integrally formed, by insert-molding or the like, at an outer periphery portion of the push plate 46, which is made of stainless steel. In the description below, the dimensions, shape and the like of the cover member 42 in the state in which the lower blade 36 is retained by the push plate 46 are described.

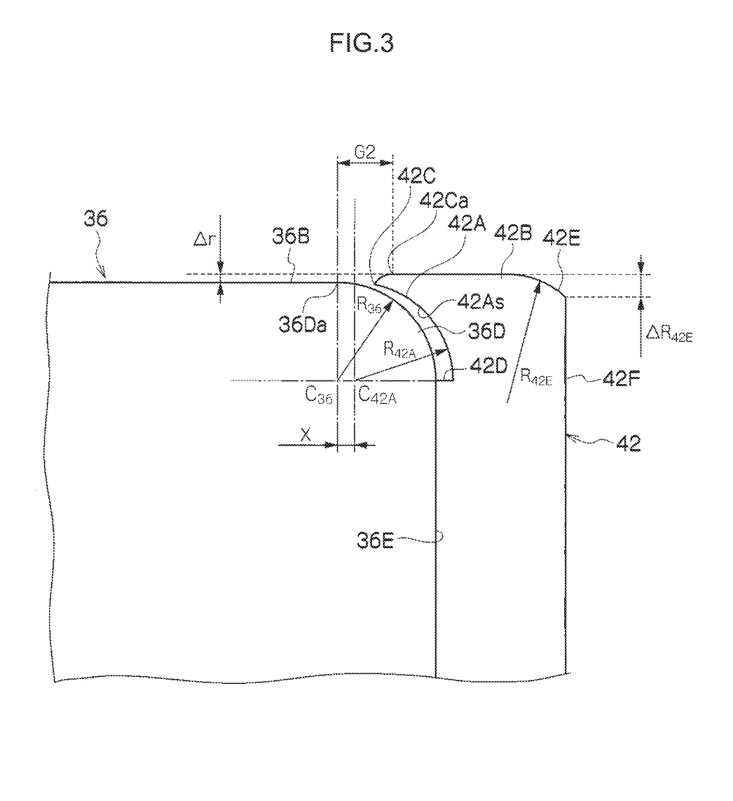

The cover member 42 includes a cover portion 42A and a support portion 42B. The cover portion 42A protrudes toward the lower blade 36 relative to the push plate 46, and covers the shoulder curve portion 36D of the lower blade 36. The support portion 42B supports the inkjet paper 11 at the opposite side of the lower blade 36 from the side at which the blade tip 36A is disposed. As illustrated in FIG. 3, which is a sectional diagram in which hatching is not drawn, the cover portion 42A covers the shoulder curve portion 36D without touching it. Herebelow, this is concretely described.

The outer diameter of the cover member 42 is slightly larger than the outer diameter of the outer periphery face 36B of the lower blade 36. In this exemplary embodiment, a radius difference Δr between the outer radius of the cover member 42 and the outer radius of the outer periphery face 36B of the lower blade 36 is set in a range from 0 to 0.1 mm. A free end 42C of the cover portion 42A in the axial direction is curved so as to match the outer radius of the outer periphery face 36B of the lower blade 36. A gap G2 between an starting point 36Da of the shoulder curve portion 36D in the axial direction and a base point 42Ca of the curve of the free end 42C in the axial direction is set to not more than 1.8 mm (to 1.8 mm in the present exemplary embodiment).

An inner periphery face 42As of the cover portion 42A has a curve with a radius R_{42A} of 3 mm, and matches the size of the radius R₃₆ of the shoulder curve portion 36D that the cover portion 42A covers. The inner periphery face 42As is formed with a center C_{42A} of the curved shape of the cover portion 42A being offset by a distance x in the axial direction from a center C₃₆ of the curve of the shoulder curve portion 36D in the assembled state. In this exemplary embodiment, x is set to equal 0.1 mm. Correspondingly, a spacer portion 42D is provided at the base side of the cover portion 42A. The spacer portion 42D abuts against an end face 36E at the opposite side of the lower blade 36 from the side at which the blade tip 36A is disposed, and maintains the separation x.

At the cover member 42, because the radius difference Δr is set as described above, the stiffness of the free end 42C is assured when the radius R_{42A} of the inner periphery face 42As is set to 3 mm. Thus, contact between the free end 42C, that is, the cover portion 42A, and the lower blade 36 is prevented or effectively suppressed.

An end portion of the support portion 42B of the cover member 42 at the opposite side thereof from the side at which the cover portion 42A is disposed serves as a shoulder curve portion 42E with a specified curve. A radius R_{42E} of this shoulder curve portion 42E is set in a range from 3 mm to 12 mm. In this exemplary embodiment, R_{42E} is set to equal 9 mm to 12 mm. The shoulder curve portion 42E is specified with a range of less than 90°. Rather than being smoothly joined to a tubular surface that is the outer periphery surface of the support portion 42B, the shoulder curve portion 42E forms a corner with an axial direction end face 42F of the support portion 42B. Thus, the shoulder curve portion 42E is set to a relatively large radius on the cover member 42 whose width in the axial direction is limited. In this exemplary embodiment, a radius difference ΔR_{42E} between a radius of the corner portion between the shoulder curve portion 42E and the end face 42F and the radius of the outer periphery surface of the support portion 42B is 3 mm.

In the cutting device 14 described above, a tension of the inkjet paper 11 is set in a range from 166 N/m to 731 N/m. In this exemplary embodiment, the tension of the inkjet paper 11 at the cutting device 14 is set to 731 N/m.

In the cutting device 14, a speed V₃₀ of the blade tip 30A of the upper blade 30 and a speed V₃₆ of the blade tip 36A of the lower blade 36 are both made faster than a conveyance speed V₁₁ of the inkjet paper 11. A rate of acceleration (proportional difference in velocity) at the upper blade 30 relative to the conveyance speed V₁₁ of the inkjet paper 11 is set to 0% to 6% and a rate of acceleration at the lower blade 36 relative to the conveyance speed V₁₁ of the inkjet paper 11 is set to 0% to 0.24%. In this exemplary embodiment, the acceleration rate at the upper blade 30 side is 3.3% to 6.0% (varying depending on abrasion states of the blade tip 30A) and the acceleration rate at the lower blade 36 side is 0.24%.

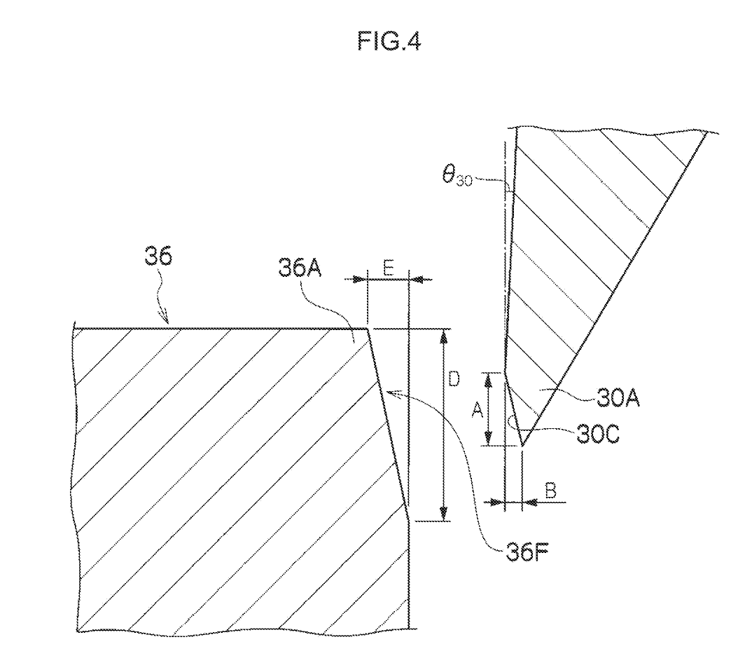

As illustrated in FIG. 4, a bevel portion 30C for which an escape angle θ₃₀ is specified is formed at the blade tip 30A of the upper blade 30. The escape angle θ₃₀ is set to 3°. A radial direction dimension A of the bevel portion 30C is set to 20 μm to 40 μm, and a thickness (axial) direction dimension B is set to 1 μm to 3 μm. Meanwhile, a bevel portion 36F is formed at the blade tip 36A of the lower blade 36. A radial direction dimension D of the bevel portion 36F is set to 40 μm to 70 μm, and a thickness (axial) direction dimension E is set to 2 μm to 6 μm.

A material of the upper blade 30 is a hard alloy. In this exemplary embodiment, the upper blade 30 is constituted with a material with a Vickers hardness of not less than 1500 HV. In the cutting device 14, a pressing force of the upper blade 30 against the lower blade 36 is set to 3 N to 20 N (10 N in this exemplary embodiment), and a radial direction meshing amount is set to 0.5 mm to 1.5 mm (0.8 mm in this exemplary embodiment). This weak pressing force is applied by an unillustrated plate spring.

In the cutting device 14, as illustrated in FIG. 8, with respect to a center line CL passing through the centers of rotation of the upper blade 30 and the lower blade 36, an angle formed by a position at which the inkjet paper 11 first touches the lower blade 36 is α1, an angle formed by a position at which the inkjet paper 11 separates from the lower blade 36 is α2, and angles formed by positions of intersection of the upper blade 30 with the lower blade 36 are β. Accordingly, α1>β and α2>β. In this exemplary embodiment, β≈6.66°, α1=40°, and α2=10°. The entry angle α1 and exit angle α2 with respect to the cutting device 14 are set by the guide roller 22 and the guide roller 24.

Next, operation of the present exemplary embodiment is described.

In the inkjet paper fabrication device 10 with the structure described above, the inkjet paper 11 is conveyed at the predetermined conveyance speed V₁₁ by operation of the feeding section 12 and the winding section 16. The inkjet paper 11 is guided by the guide roller 22 and led into the cutting device 14 at the predetermined entry angle α1, and is guided by the guide roller 22 and led out from the cutting device 14 at the predetermined exit angle α2.

In the cutting device 14, the upper blade 30 cuts the inkjet paper 11 from the side of the paper 26, which is the base material. Therefore, feathering (fluffing) of cut faces of the inkjet papers 11 (at the ink-receiving layer 28 side) is prevented or effectively suppressed from occurring.

During cutting, as illustrated in FIG. 7A, the inkjet paper 11 is supported from the ink-receiving layer 28 side by the lower blade 36 and the collar 40 at both sides in the width direction relative to a cutting position 11C of the inkjet paper 11. As mentioned above, a speed difference is set between the conveyance speed of the inkjet paper 11 and a peripheral speed of the lower blade 36 and the collar 40. Therefore, there is relative displacement in the rotation direction between the inkjet paper 11 and the lower blade 36 (the cover member 42) and collar 40. In addition, relative displacements in the width direction (the axial direction of the lower blade unit 20) are caused by movements of the inkjet paper 11 in the width direction.

Abrasion may be caused at the surface of the ink-receiving layer 28 of the inkjet paper 11 by relative displacement of the lower blade 36 (the cover member 42) and the collar 40. In particular, because the lower blade 36 and the collar 40 protrude in the radial direction relative to other portions of the lower blade unit 20 and have narrow widths relative to the width of the inkjet paper 11, stresses tend to concentrate in the inkjet paper 11 at two axial direction end portions that coincide in the width direction with the lower blade 36 and the collar 40. Therefore, at stress concentration portions 11S, which are represented by broken lines in FIG. 7B, abrasion may occur at the surface of the ink-receiving layer 28 of the inkjet paper 11.

In the cutting device 14, a portion of the collar 40 including the two axial direction end portions is constituted with PTFE. Therefore, damage to the surface of the ink-receiving layer 28 of the inkjet paper 11 is suppressed. In particular, because the two axial direction end portions of the collar 40 are formed as the shoulder curve portions 40B and 40C with radiuses of at least 3 mm, damage to the surface of the ink-receiving layer 28 of the inkjet paper 11 that is wound around the collar 40 is effectively suppressed.

Similarly, the material of the cover member 42 in the cutting device 14 is PTFE, and the shoulder curve portion 42E with a radius of at least 3 mm is specified at the axial direction end portion of the support portion 42B. Therefore, damage to the surface of the ink-receiving layer 28 of the inkjet paper 11 that is wound around the cover member 42 is effectively suppressed.

These points are described by comparison with Comparative Examples illustrated in table 1. Table 1 is an evaluation of abrasion of surfaces of the ink-receiving layer 28, in which ‘A’ represents that no abrasion occurs, ‘B’ represents slight abrasion (within a tolerable range), and ‘C’ represents obvious abrasion (at a non-tolerable level).

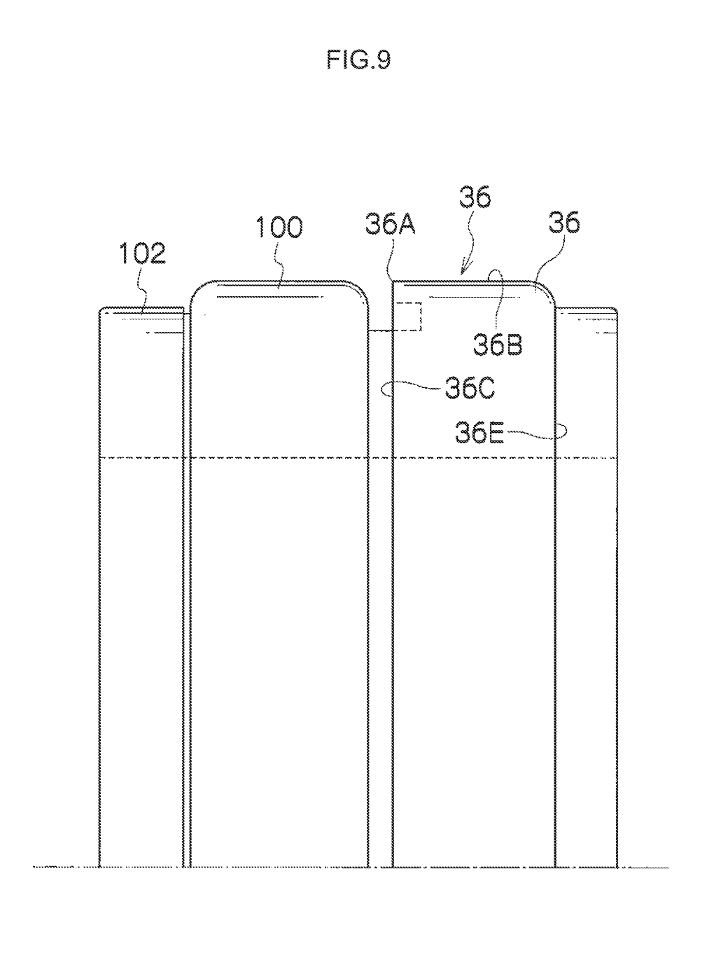

In the Comparative Examples described below, a structure is assumed in which, instead of the collar and cover member being constituted with PTFE (the Example in the bottom row of table 1), as illustrated in FIG. 9, a collar 100 in place of the collar 40 is formed integrally with a lower blade holder 102 that is made of steel and the cover member 42 covering the shoulder curve portion 36D of the lower blade 36 is not provided.

When the collar and lower blade were constituted with a high hardness Martensitic stainless steel such as SUS440C (JIS standards), the evaluation result was ‘C’ regardless of the radius of the shoulder curve portions. Even if the friction coefficient was reduced by grinding the SUS440C, the result was ‘C’ regardless of the radius of the shoulder curve portions. When the friction coefficient was reduced by coating the surface of the SUS440C to a thickness of 40 μm with PTFE (in this case, PFA (a tetrafluoroethylene-perfluoroalkyl vinylether copolymer)), the result was ‘B’ if the radius of the shoulder curve portions was 12 mm to 30 mm but the result was ‘C’ with other radiuses of the shoulder curve portions. Similarly, when the friction coefficient was reduced by coating the surface of the SUS440C to a total thickness of 150 μm with PTFE (in this case, PFA and PPS (polyphenylidene sulfide), the result was ‘B’ if the radius of the shoulder curve portions was 12 mm to 30 mm but the result was ‘C’ with other radiuses of the shoulder curve portions. When the friction coefficient was reduced by coating the SUS440C with DLC (diamond-like carbon), the result was ‘C’ regardless of the radius of the shoulder curve portions.

TABLE 1

| Material of | Radius of shoulder curve portions | | | | | | | | |
|---|---|---|---|---|---|---|---|---|---|
| collar and | of collar and cover member (mm) | | | | | | | | |
| cover member | 1 | 2 | 3 | 6 | 9 | 12 | 15 | 30 | 40 |
| SUS440C | C | C | C | C | C | C | C | C | C |
| Hub-ground | C | C | C | C | C | C | C | C | C |
| SUS440C | | | | | | | | | |
| 40 μm PTFE | C | C | C | C | C | B | B | B | C |
| coating | | | | | | | | | |
| 150 μm PTFE | C | C | C | C | C | B | B | B | C |
| coating | | | | | | | | | |
| DLC coating | C | C | C | C | C | C | C | C | C |
| PTFE | C | B | A | A | A | A | A | A | C |

In contrast, when the collar and cover member are constituted with PTFE, and support stiffness of the inkjet paper 11 is reduced and the coefficient of friction is reduced, the ‘A’ result was obtained with radiuses of the shoulder curve portion in the range from 3 mm to 30 mm. It is thought that the ‘B’ and ‘C’ results when the radius of the shoulder curve portions is 2 mm or less is because concentrations of stress occur at the stress concentration portions 11S because the curvature is greater (the radius of curvature is small). On the other hand, when the radius of the shoulder curve portions is 40 mm or more, it is thought that a region that serves as the tubular surface at the outer periphery of the cover member is not formed in the width range thereof, and concentrations of stress occur at a peak portion at the middle of the cover member in the width direction (a portion that serves as a contact point in a sectional view).

Thus, the collar 40 and cover member 42 structuring the cutting device 14 relating to the present exemplary embodiment are constituted with PTFE, and the radiuses of the curves of the shoulder curve portions 40B, 40C and 42E are 3 mm to 12 mm. Therefore, from table 1, the formation of non-tolerable abrasions at the surface of the ink-receiving layer 28 of the inkjet paper 11 is prevented. When the cover member 42 is supplementary described, the cover member 42 covers the shoulder curve portion 36D of the lower blade 36 with the cover portion 42A. Thus, the shoulder curve portion 36D that is relatively hard and has a high coefficient of friction is prevented from touching the inkjet paper 11, and concentrations of stress in the inkjet paper 11 due to contact with the shoulder curve portion 36D are prevented (moderated). Moreover, because the shoulder curve portion 42E with a radius of 3 mm to 12 mm is formed at the cover member 42 made of PTFE, concentrations of stress in the inkjet paper 11 that are caused by the cover member 42 itself are prevented (moderated).

At the cover member 42, the radius difference Δr between the outer radius of the cover member 42 and the outer radius of the outer periphery face 36B of the lower blade 36 is set in the range 0 to 0.1 mm. In consequence, as illustrated in table 2, abrasion of the surface of the ink-receiving layer 28 of the inkjet paper 11 is prevented or effectively suppressed. In table 2, the evaluation results ‘A’, ‘B’ and ‘C’ have the same meanings as the evaluation results in table 1.

TABLE 2

| | Radius difference | | | | | | |
|---|---|---|---|---|---|---|---|
| | Δr (mm) | | | | | | |
| | −0.10 | −0.05 | ±0 | +0.05 | +0.10 | +0.15 | +0.20 |
| Abrasion | C | B | A | A | A | B | C |
| evaluation | | | | | | | |

It is thought that the results are ‘C’ or ‘B’ when the outer radius of the cover member 42 is smaller than the outer radius of the lower blade 36 (Δr is negative) because the shoulder curve portion 36D causes a concentration of stress in the inkjet paper 11. On the other hand, it is thought that the results are C or B when Δr is +0.15 mm or more because the difference in radius between the cover portion 42A of the cover member 42 and the outer periphery face 36B (a step difference) causes a concentration of stress in the inkjet paper 11.

Furthermore, at the cover member 42, the gap G2 between the base point 42Ca of the free end 42C and the starting point 36Da of the shoulder curve portion 36D is set to 1.8 mm or less. In consequence, abrasion of the surface of the ink-receiving layer 28 of the inkjet paper 11 is prevented or effectively suppressed. It is confirmed that if this gap G2 is 3 mm or more, the shoulder curve portion 36D is exposed and concentrations of stress are formed in the inkjet paper 11, and abrasion of the surface of the ink-receiving layer 28 is frequent.

In the inkjet paper fabrication device 10, the entry angle α1 of the inkjet paper 11 into the cutting device 14 is set to be significantly greater than the angles β of the positions of intersection of the upper blade 30 with the lower blade 36. Thus, cut faces of the inkjet papers 11 and quality of the ink-receiving layer 28 are assured. This point is supplemented by reference to table 3. Table 3 shows evaluation results of cracking of the ink-receiving layer 28 (the silica layer) and feathering up (feathering) of the cut faces. ‘A’ represents results in a tolerable range (sporadic occurrence), ‘B’ represents results at the limits of tolerance, and ‘C’ represents non-tolerable results (frequent occurrence).

TABLE 3

| | Entry angle α1 (°) | | | | | | | | | | | | | | | | | | |
|---|---|---|---|---|---|---|---|---|---|---|---|---|---|---|---|---|---|---|---|
| | 0 | 1 | 2 | 3 | 4 | 5 | 6 | 7 | 8 | 9 | 10 | 11 | 12 | 13 | 14 | 15 | 20 | 30 | 40 |
| Cracking | C | C | C | C | C | C | C | C | B | B | A | A | A | A | A | A | A | A | A |
| Feathering | A | A | A | A | A | A | A | A | A | A | A | A | A | A | A | A | A | A | A |

From table 3, it is seen for feathering that ‘A’ results were obtained regardless of the entry angle, due to the inkjet paper 11 being cut from the paper 26 side as described above. For cracking of the ink-receiving layer 28 however, it is seen that ‘A’ results were obtained with the entry angle α1 being 10° or more. On the other hand, when the entry angle was 7° or less, corresponding to being not more than roughly the angles β of the positions at which the upper blade 30 and the lower blade 36 intersect, cracking of the ink-receiving layer 28 was evaluated as ‘C’. When the input angle α1 is 8° to 9°, corresponding to being close to the angles β, the results were ‘B’.

In the cutting device 14, the tension of the inkjet paper 11 during cutting is set in a range from 166 N/m to 731 N/m. In consequence, cut faces of the inkjet paper 11 and quality of the ink-receiving layer 28 are assured. This point is supplemented by reference to table 4. Table 4 shows evaluation results of cracking of the ink-receiving layer 28, feathering of the cut faces and abrasion of the surface of the ink-receiving layer 28. ‘A’ represents results in a tolerable range (sporadic occurrence), ‘B’ represents results at the limits of tolerance, and ‘C’ represents non-tolerable results (frequent occurrence).

TABLE 4

Tension (N/m)

| | 100 | 166 | 356 | 546 | 731 | 921 |
|---|---|---|---|---|---|---|
| Cracking | C | A | A | A | A | B |
| Feathering | C | A | A | A | A | A |
| Abrasion | A | A | A | A | A | C |

From table 4, in the condition in which the tension of the inkjet paper 11 is 100 N/m, cracking of the ink-receiving layer 28 and feathering of the cut faces give ‘C’ results. This is thought to be because the inkjet paper 11 is not thoroughly retained, because of the low tension, and is cut in an unstable condition. For abrasion, frictional force (friction resistance) is reduced in the low tension condition, and consequently the table gives an ‘A’ result. On the other hand, in the 921 N/m condition, the friction resistance (pressing force) is high because of the high tension. Consequently, it is seen that abrasion occurs because of friction between the relatively displacing inkjet paper 11 and the collar 40 and cover member 42.

When the tension of the inkjet paper 11 is low, it is easy for the cut inkjet papers 11 to slip in the width direction during winding of the inkjet papers 11 after cutting. Therefore, it is desirable for the tension of the inkjet paper 11 to be set higher in the range from 166N/m to 731 N/m.

In the cutting device 14, the speed V₃₀ of the upper blade 30 is increased within a predetermined range relative to the conveyance speed V₁₁ of the inkjet paper 11. Thus, the cut faces of the inkjet papers 11 and the quality of the ink-receiving layer 28 are assured. This point is supplemented by reference to table 5. Table 5 shows evaluation results of cracking of the ink-receiving layer 28 (the silica layer) and feathering up (feathering) of the cut faces. ‘A’ represents results in a tolerable range (sporadic occurrence), ‘B’ represents results at the limits of tolerance, and ‘C’ represents non-tolerable results (frequent occurrence).

TABLE 5

| | Speed increase ratio of upper blade | | | | |
|---|---|---|---|---|---|
| | relative to paper conveyance speed (%) | | | | |
| | −3 | 0 | 3 | 6 | 9 |
| Cracking | C | B | A | A | C |
| Feathering | C | B | A | A | A |

From table 5, it is seen that cracking of the ink-receiving layer 28 and feathering of the cut faces both give ‘C’ or ‘B’ results when the speed increase ratio is 0% or less. This is thought to be because, while the upper blade 30 cuts into the inkjet paper 11 when the speed V₃₀ of the upper blade 30 is above the conveyance speed V₁₁ of the inkjet paper 11, the inkjet paper 11 is closer to a condition in which the inkjet paper 11 is being torn by the upper blade 30 when the speed V₃₀ is at or below the conveyance speed V₁₁. On the other hand, when the rate of speed increase is 9%, cracking of the ink-receiving layer 28 gives ‘C’ results. This is thought to be because friction between the blade tip 30A of the upper blade 30 and the cut face of the inkjet paper 11 is strong and deformation of the ink-receiving layer 28 increases.

In the cutting device 14, the collar 40 is integrally constituted of PTFE as a whole. Therefore, the outer periphery face 40A does not form a step or the like and rises smoothly, which contributes to suppressing damage to the surface of the ink-receiving layer 28. Moreover, the structure of the collar 40 is simple, and the collar 40 whose surface has low friction and high stiffness may be obtained with ease.

At the lower blade unit 20 that structures the cutting device 14, the collar 40 is mated with the first mating portion 38B of the lower blade holder 38 and axial direction movement is restricted (stopped) by the base portion 38A (the step portion 38E) and the middle ring 44 while the gap G1 therebetween is maintained. In consequence, the collar 40 that is formed of PTFE and has relatively low stiffness is not subjected to restraint in the axial direction (a fastening force of the bolt 50), and deformation of the collar 40 is prevented. Thus, dimensional precision of the outer periphery face 40A that is the winding face of the collar 40 is assured. Therefore, concentrations of stress in the inkjet paper 11 wound around the collar 40 are prevented or effectively suppressed, which contributes to preventing occurrences of abrasion as described above. In particular, because the spacer member that is retained at the lower blade holder 38 without restraining the collar 40 is the ring-shaped middle ring 44, assembly of the collar 40 to the lower blade holder 38 is simple.

Furthermore, the middle ring 44 features the function of maintaining the gap D between the collar 40 and the end face 36C (the blade tip 36A) of the lower blade 36. The middle ring 44 also features the function of assuring dimensional precision of the blade tip 36A relative to the reference surface 38AS. Thus, the middle ring 44 combines three functions, and thus simplifies the structure of the lower blade unit 20.

In the cutting device 14, the cover member 42 is integrally formed at the outer periphery of the push plate 46 that retains the lower blade 36 at the lower blade holder 38. Therefore, the cover member 42 that is formed of PTFE and has relatively low stiffness is not subjected to restraint (the fastening force of the bolt 50) in the axial direction, and dimensional precision thereof is assured. In consequence, similarly to the collar 40 described above, concentrations of stress in the inkjet paper 11 wound around the cover member 42 are prevented or effectively suppressed, which contributes to preventing occurrences of abrasion as described above.

In the cutting device 14, the upper blade 30 is constituted with a hard alloy and the bevel portions 30C and 36F are formed at the upper blade 30 and the lower blade 36. Further, in the cutting device 14, a pressing force (contact surface pressure) of the upper blade 30 on the lower blade 36 is set to be weak, between 3 N and 20 N. Thus, while cutting quality of the inkjet paper 11 is maintained, a longer lifespan of the blade tip 30A of the upper blade 30 is enabled.

Supplementary to this point, if the hardness of the material that constitutes the upper blade 30 is of the order of 800 HV, the upper blade 30 will be severely worn by cutting the ink-receiving layer 28, of which silica with a hardness at around 500 HV is a principal component, and replacement of the upper blade 30 will be required at a cutting distance of around 200 km. In contrast, it is confirmed that when the upper blade 30 is constituted with a hard alloy of 1500 HV or above, the cutting distance to replacement is at least ten times that. On the other hand, when the upper blade 30 is constituted with this kind of hard alloy, if a pressing force from the upper blade 30 against the lower blade 36 is set to a value exceeding 20 N (for example, 20 N to 23 N), cracking occurs at an extreme distal end portion of the blade tip 30A, which may lead to a deterioration of cutting quality.

However, when the pressing force of the upper blade 30 against the lower blade 36 is set to 10 N or less as mentioned above, cracking of the blade tip 30A is greatly suppressed, and both cutting quality and a long lifespan of the upper blade 30 are enabled. However, if the pressing force is less than 3 N, it is verified that the cut face is feathered as a result of vibrations during cutting conveyance.

The cutting device 14 and cutting method relating to the present exemplary embodiment as described above contribute to fabrication of the inkjet paper 11 with an excellent cut face and surface of the ink-receiving layer 28. Furthermore, the fabrication device 10 relating to the present exemplary embodiment may fabricate the inkjet paper 11 with an excellent cut face and surface of the ink-receiving layer 28. Therefore, with the inkjet paper fabrication device 10, a defect rate of the inkjet papers 11 after cutting by the cutting device 14 is greatly reduced, and a high production efficiency (yield) is realized.

The present invention is not to be limited to the exemplary embodiment described above, and may obviously be embodied with various modifications. As an example, resin materials constituting the collar 40 and the cover member 42 are not to be limited to PTFE; materials with required friction coefficients and resiliencies may be employed. As a further example, the structure of the collar 40 that is formed of PTFE is not limited to being the whole thereof; just portions corresponding to the shoulder curve portions 40B and 40C may be structured with PTFE.

What is claimed is:

1. A cutting object cutting device comprising:
a lower blade that is formed in a circular tube shape around which a cutting object is wound, a blade tip being formed at an outer periphery portion of the lower blade at one end of an axial direction thereof, and the lower blade rotating in a direction of running of the cutting object in the state in which the cutting object is wound therearound, and the cutting object including a coating layer formed on a substrate, the coating layer being harder than the substrate;
an upper blade, at an outer periphery portion of which a blade tip that progressively narrows toward a radial direction outer side is formed, the upper blade cutting the cutting object from the substrate side thereof while rotating about an axis that is parallel to the axis of the lower blade such that the blade tip opposes the blade tip of the lower blade; and
a support member that is disposed so as to rotate coaxially and integrally with the lower blade at a position that is separated from the lower blade in the axial direction, at least an axial direction end portion of the support member being constituted with a resin material, the support member rotating together with the lower blade, and the supporting member supporting the cutting object with the cutting object being wound around the support member at a portion including the axial direction end portion.

2. The cutting object cutting device according to claim 1, wherein the support member is disposed so as to sandwich the blade tip of the upper blade between the support member and the lower blade in the axial direction, at least both end portions of the support member in the axial direction are constituted with the resin material, and curves are specified at corners of the end portions.

3. The cutting object cutting device according to claim 2, wherein a radius of the curves of the support member is specified in a range from 3 mm to 12 mm.

4. The cutting object cutting device according to claim 1, wherein the whole of the support member is integrally constituted of the resin material.

5. The cutting object cutting device according to claim 1, wherein the lower blade includes a small diameter portion at the axial direction end portion that is at the opposite side thereof from the side at which the blade tip is disposed, the small diameter portion being set to a smaller diameter than other portions of the lower blade, and the cutting object cutting device further includes a cover member made of resin that covers the small diameter portion from the outer periphery side thereof, and that rotates together with the lower blade while supporting the cutting object, the cutting object being wound around the cover member.

6. The cutting object cutting device according to claim 5, wherein the small diameter portion of the lower blade is a curve specified at a corner portion, the cover member is structured to include a cover portion that covers the curve from the outer periphery side and a support portion that supports the cutting object at the opposite side of the cover portion from the side at which the lower blade is disposed, and the support portion of the cover member includes a curve at a corner of an axial direction end portion thereof, the curve being specified with a radius in a range from 3 mm to 12 mm.

7. The cutting object cutting device according to claim 5, further comprising: a retention member that retains the support member mating with a first mating portion that is longer than a width along the axial direction of the support member, and that retains the lower blade mating with a second mating portion with a smaller diameter than the first mating portion; and a spacer member that abuts against a step portion between the second mating portion and the first mating portion and that protrudes to the radial direction outer side relative to the first mating portion, and that regulates a gap in the axial direction between the support member and the lower blade.

8. The cutting object cutting device according to claim 7, wherein the spacer member comprises a ring member, an outer diameter of which is larger in diameter than the first mating portion and an inner periphery of which mates with the second mating portion, and that is interposed between the lower blade and the step portion.

9. The cutting object cutting device according to claim 7, further comprising a push plate that is fastened to the retention member from the opposite side of the lower blade from the side at which the spacer member is disposed, the lower blade being interposed between the push plate and the spacer member, wherein the cover member is disposed at an outer periphery portion of the push plate.

10. The cutting object cutting device according to claim 1, wherein a tension of the cutting object is specified in a range from 166 N/m to 731 N/m.

11. An inkjet paper fabrication device comprising:
a running mechanism that runs inkjet paper in which an ink-receiving layer is formed on a substrate, the ink-receiving layer being harder than the substrate; and
the cutting object cutting device according to claim 1 that is disposed on a path of running of the inkjet paper due to the running mechanism and that cuts the inkjet paper, which serves as the cutting object.
